(19) United States
(12) Patent Application Publication
(10) Pub. No.: US 2002/0100050 A1
(43) Pub. Date: Jul. 25, 2002

(54) Methods and systems for audio distribution over aircraft telecommunications wiring

(76) Inventor: Marty J. Ryberg, Renton, WA (US)

Correspondence Address: Samuel H. Dworetsky, AT&T CORP., P.O. Box 4110, Middletown, NJ, 07748-4110, US

(21) Appl. No.: 09/853,137

(22) Filed: May 10, 2001

Related U.S. Application Data
(60) Provisional application No. 60/257,271, filed on Dec. 21, 2000.

(51) Int. Cl. H04N 7/18; H04N 7/173

(52) U.S. Cl. 725/76; 725/86

(57) ABSTRACT

Integrated seat units for aircraft. The systems take all incoming signals that will be used by a passenger sitting in an aircraft seat and route the signals to receivers that the passenger can access. The signals may be routed over the aircraft bus in a wireline or wireless environment.

### RELATED APPLICATIONS

This application claims priority under 35 U.S.C. §119 from Provisional U. S. Patent Application Serial No. 60/257271, filed on Dec. 21, 2000 entitled Methods and Systems for Audio Distribution Over Aircraft Telecommunications Wiring.

### BACKGROUND OF THE INVENTION

1. Field of the Invention

This invention relates generally to methods and systems for distributing data over aircraft telecommunications wiring. More specifically, the invention relates to distributing integrated, and combined or reformatted audio/video and other signals over aircraft telecommunications wiring.

2. Description of the related art

With the current explosion of wireless and Internet technologies, data distribution over phone lines and existing networks is taking place at an ever-increasing rate and at faster speeds. Networks of this nature are becoming ubiquitous, and may be found in many different environments. From wireless intranets, local area networks (LANs) and wide area networks (WANs), to mobile networks found on airplanes, ships at sea and other modes of transportation, the desire is strong to transport data and other signals efficiently and economically.

One such network is a conventional telephone system found in an airplane, for example. Such telephone systems provide passengers with a number of telephone handsets for use in making telephone calls. These telephone systems have wiring that is used exclusively by the telephone system. Each seat in the airplane that is equipped with a telephone handset is associated with a telephone signal distribution unit remote from the handset that is used exclusively with the telephone handset. Airplanes are also equipped with communication systems other than telephone systems, for example intercom systems that provide airplane passengers with crew announcements. Yet other communication systems on airplanes, for example systems that provide video and/or audio signals, are similar to the intercom system in that they provide sound and other signals to airplane passengers. These systems also comprise wiring that is used exclusively by that particular system. Each seat on the airplane that is equipped with access to these other types of systems, especially those related to audio delivery, is associated with a seat unit that is exclusive to the particular audio delivery system and which is usually remote from the actual physical location of the delivery of the signal to the user of the seat.

Unfortunately, all of the above-referenced disparate communication systems with their associated signal distribution units and separate wiring add to the bulk, weight and complexity of the airplane's electronic data systems. This is detrimental to the efficient operation of the aircraft and detracts from the aircraft's serviceability. Moreover, separate wiring and distribution units create undesirable redundancy in the design of the aircraft, making it difficult to diagnose and troubleshoot problems which may appear in the different systems.

There thus exists a long-felt need for methods and systems which broadcast audio and/or other signals and data over telecommunication wiring associated with a minimal number of aircraft systems. Moreover, it would be desirable if such systems and methods eliminated the need for separate audio and telecommunications wiring and that sending and receiving circuitry could be integrated into a single electrical unit. These systems and methods should be simple to design and retrofittable to existing aircraft. These needs have not heretofore been achieved in the art.

### SUMMARY OF THE INVENTION

The aforementioned problems are solved, and long-felt needs met, by integrated communication systems for aircraft having at least one passenger seat provided in accordance with the present invention. Preferably, the systems comprise a seat unit operable to receive and transmit a plurality of signals to and from a user of the at least one passenger seat in the aircraft. More preferably, the systems comprise aircraft communication links interface with the seat unit for carrying the plurality of signals throughout the aircraft from sources of the plurality of signals. Still more preferably, a receiving unit is interfaced in the at least one passenger seat and in communication with the seat unit for receiving the plurality of signals and outputting a message to a passenger in the passenger seat.

The invention is particularly useful in aircraft where multiple sources of signals and messages are forwarded to passengers sitting in aircraft seats. The invention may be customized for any particular passenger aircraft, and is also retrofittable in existing aircraft that comprise an aircraft bus for transporting signals throughout the aircraft. The systems of the present invention are usable with wireline communication systems and in a wireless environment. Moreover, the present invention makes it possible to reformat audio (or other data) and pass it as telecommunications data on unused channels or existing telecommunication wiring such that separate audio and telecommunications wiring is not necessary. Additionally, sending and receiving electronics or circuitry may be integrated into a single electronic unit in accordance with the present invention. Such results have not heretofore been achieved in the art.

These and other features of the present invention will become apparent from the following detailed description considered in conjunction with the accompanying drawings. It is to be understood, however, that the drawings are designed solely for purposes of illustration and not as a definition of the limits of the invention.

### BRIEF DESCRIPTION OF THE DRAWINGS

In the drawings wherein like reference numerals refer to like elements throughout the several views thereof:

FIG. 1 is a block diagram of a prior art system that buses signals to passengers in aircraft seats; and

FIG. 2 is a block diagram of a preferred embodiment of the systems provided in accordance with the present invention for integrating transport of signals in an aircraft.

### DETAILED DESCRIPTION OF THE PREFERRED EMBODIMENTS

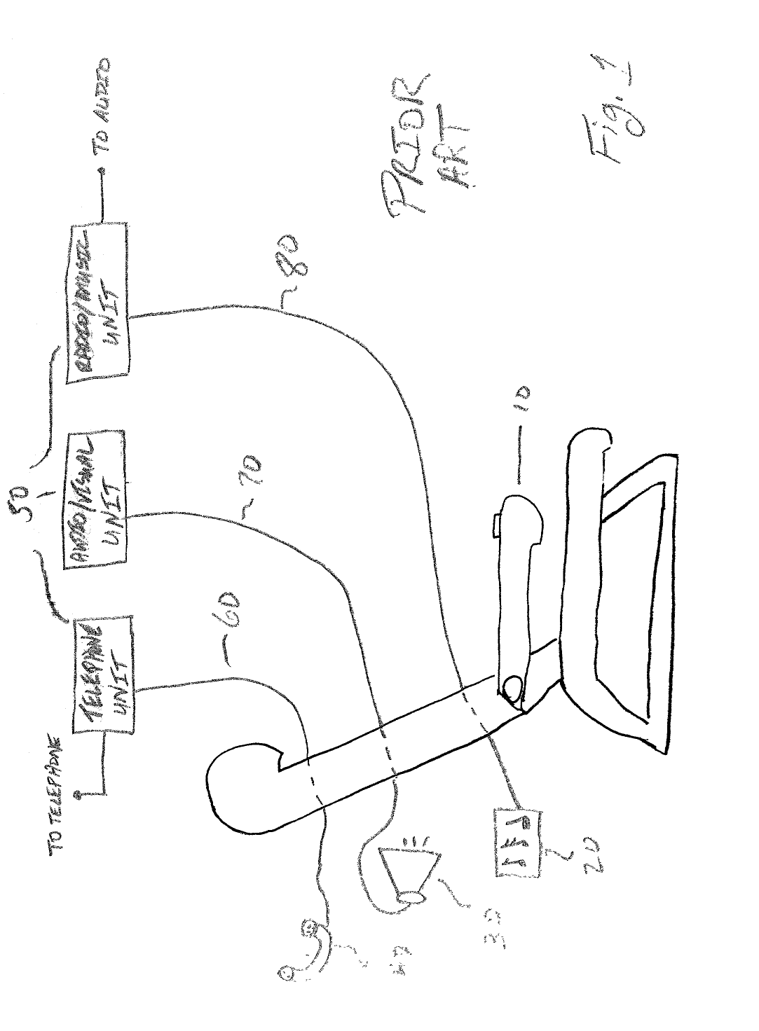

Referring now to FIG. 1, a prior art system is depicted for routing a plurality of signals throughout an aircraft, and particularly to an aircraft seat 10 which may seat a user during the flight of the aircraft. Typically, the prior art system includes several different types of audio/video or other output devices to stimulate or otherwise provide to a user the desired audio and/or video signals such as music 20, video 30 and telephone 40 signals. The music and telephone signals 20, 40 are typically supplied to the user in seat 10 through physical apparatus or devices (not shown) such as headphones or handsets, respectively, while the video signals 30 are typically provided to the seat 10 through a combination of a video monitor and headphones for the audio portion. This allows the seat's user to interact with the physical apparatus or devices to receive signals 20, 30, 40.

As can be seen in FIG. 1, each of the signals 20, 30, 40 is associated with a separate distribution unit 50 specifically and exclusively adapted to provide the particular signal which is bussed to the physical apparatus or device at the seat 10. This requires a separate communication link 60, 70, 80 which are each in one-to-one correspondence with a specific physical apparatus or device operable to receive the signal 20, 30 or 40. The distribution units 50 are typically located under the seat 10 in the aircraft, while other similar units, for example, intercom units are routed through overhead panels. Intercom signals usually ride along an audio distribution signal from an intercom unit at some place, usually remote from the seat 10, in the aircraft. Thus, in the specific case of FIG. 1, there are shown three separate distribution units 50 which are in some fashion in electrical communication with the seat 10, and three separate communication links 60, 70, 80, typically wirelines, which must be run through, and stowed in, the aircraft frame and seat 10. Needless to say, this is a cumbersome arrangement which occupies a large amount of aggregate space, and a great deal of the allowed weight, in the aircraft.

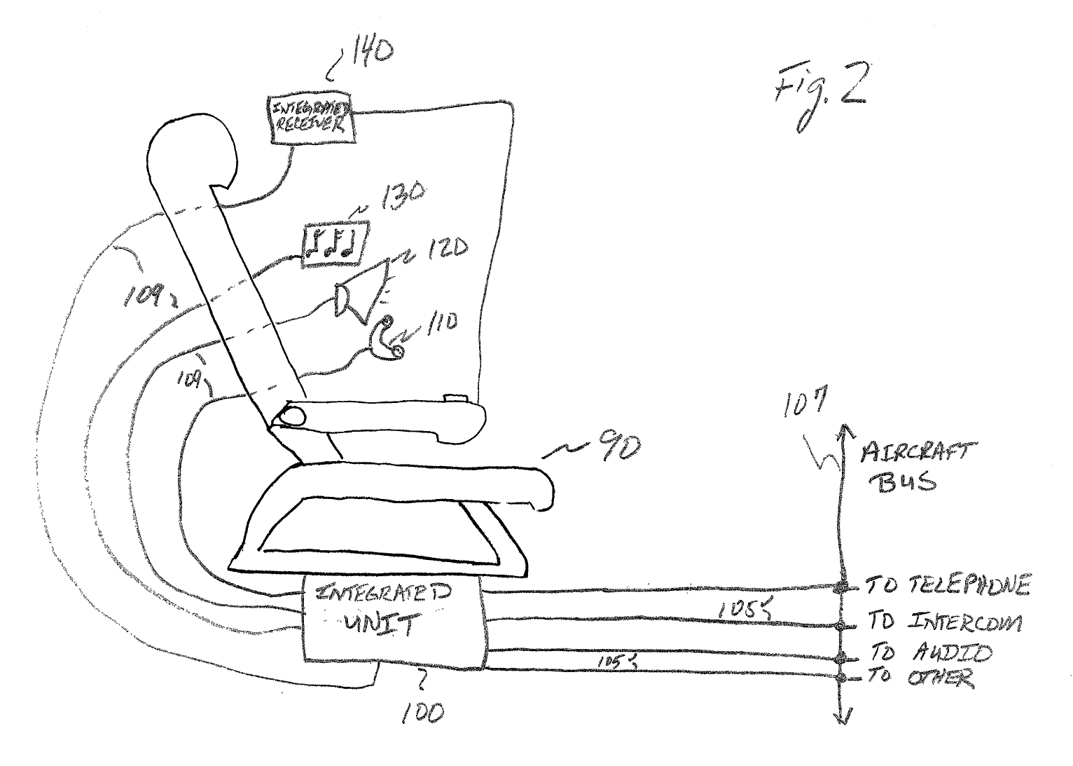

Referring to FIG. 2, the present invention integrates the distribution units 50 and communication links 60, 70 and 80, thereby alleviating the above-referenced problems and improving the overall performance of the aircraft. A seat 90 is operable to interface with an integrated unit 100 which is further adapted to receive a plurality of signals over lines 105. Lines 105 are preferably telecommunications lines for bussing the various signals, including data signals, around the aircraft. These lines are preexisting in the aircraft and may be similar, or identical to, lines 60, 70 and/or 80, although in a different configuration than that shown in the prior art system of FIG. 1.

Lines 105 allow fast and efficient integration of telecommunication signals and services to and through the aircraft, and especially to the user of seat 90, in accordance with the present invention. The communication links 105 are interfaced to an aircraft bus 107 which forwards the various signals from their respective signal generating devices (not shown) at other places in the aircraft to the integrated unit 100, which may be found in, about, or interfaced to, seat 90. The aircraft bus 107 is adapted to receive signals from signal generating devices through wireline or other wireless links. In this manner the aircraft bus 107 can carry all the necessary signals to the integrated seat unit 100 which the user of the seat 90 desires to hear or otherwise experience.

The integrated unit 100 integrates all of the signals and forwards them on through a set of links 109 to the various physical apparatus or devices, as described earlier, in the seat 90. Links 109 may be wireline or wireless links. For example, a telephone receiver 110, an audio/video monitor 120, or a radio or music speaker 130 may be interfaced in seat 90 so that the user of seat 90 may enjoy these stimuli. In this fashion, the present invention through integrated unit 100 combines together data (reformatted audio/video/other signals) and other information and sends this reformatted information over telecommunication-type wiring. This has not heretofore been achieved in the art.

An integrated receiver 140 may also be provided to seat 90 which is adapted to receive all input signals and which parses the signals and displays them to a user on a logical basis. In this fashion, many different other types of signals may also be integrated in seat 90, for example, video signals. The present invention thus provides the ability to reformat audio and/or other data and pass it on as telecommunications data on unused channels of existing telecommunications wiring such that separate audio and telecommunication wiring is not necessary. Moreover, the sending and receiving electronics as described above may be integrated into the single unit 100. These results have not heretofore been achieved in the art.

While there have been shown and described and pointed out certain novel features of the present invention as applied to preferred embodiments thereof, it will be understood by those skilled in the art that various omissions and substitutions and changes in the methods and apparatus described herein, and in their operation, may be made by those skilled in the art without departing from the spirit and scope of the invention. It is expressly intended that all combinations of those elements and/or method steps which perform substantially the same function in substantially the same way to achieve the same results are within the scope of the invention. Substitutions of method steps and elements from one described embodiment to another are also fully intended and contemplated.

What is claimed is:

1. An integrated communication system for an aircraft having at least one passenger seat, comprising:
an integrated signal unit operable to receive and transmit a plurality of signals of disparate nature to and from a user of the at least one passenger seat in the aircraft; a plurality of aircraft communication links interfaced with the integrated signal unit for carrying the plurality of signals of disparate nature throughout the aircraft from sources of the plurality of signals of disparate nature; and
a receiving device interfaced to at least one passenger seat and in communication with the integrated signal unit for receiving at least one of the plurality of signals and outputting a signal to a passenger in the passenger seat.

2. The system recited in claim 1, wherein the plurality of signals of disparate nature comprise the group consisting essentially of audio, video and data signals.

3. The system recited in claim 1, wherein the plurality of aircraft communication links further comprise telecommunications wiring.

4. The system recited in claim 3, wherein the receiving device comprises a speaker.

5. The system recited in claim 3, wherein the receiving device comprises a video monitor.

6. The system recited in claim 3, wherein the receiving device comprises a telephone handset.

7. The system recited in claim 3, wherein the receiving device comprises an intercom.

8. A communications system for use in an aircraft, comprising:
a seat unit operable to receive a plurality of signals bussed through the aircraft; a first audio processing circuit operable to generate audio signals, the first audio processing circuit being coupled to the sear unit over a wireline communication channel;
a first telephone signal processing circuit operable to receive and send telephone signals, the first telephone signal processing unit being coupled to the seat unit through the wireline communication channel;
the seat unit further comprising:
a first audio processing receiving circuit operable to receive the audio signals for processing and delivery to a passenger audio transducer;
a second telephone signal processing circuit that is operable to receive and send the telephone the telephone signals for delivery to and from a passenger telephone handset; and
electrical circuitry coupled to and shared by the first audio processing receiving circuit and the second telephone processing circuit.

9. The system recited in claim 8, wherein the plurality of signals comprise the group consistently essentially of audio, video and data signals.

10. The system recited in claim 9 wherein the first audio processing unit comprises a radio audio processing unit.

11. The system recited in claim 10, further comprising a second audio processing unit operable to generate audio and video signals and being coupled to the seat unit over a wireline communication channel.

12. The system recited in claim 11, wherein the passenger transducer comprises a speaker.

13. The system recited in claim 11, wherein the passenger transducer comprises a video monitor.

14. The system recited in claim 11, further comprising a telephone handset coupled to the first telephone signal processing unit for directing telephone signals to the passenger.
